(19) United States
(12) Patent Application Publication
(10) Pub. No.: US 2024/0055216 A1
(43) Pub. Date: Feb. 15, 2024

(54) X-RAY SOURCE AND OPERATING METHOD THEREFOR

(71) Applicant: Helmut Fischer GmbH Institut fuer Elektronik und Messtechnik, Sindelfingen (DE)

(72) Inventor: Martin Leibfritz, Deckenpfronn (DE)

(21) Appl. No.: 18/268,934

(22) PCT Filed: Dec. 21, 2021
(86) PCT No.: PCT/EP2021/087030

§ 371 Date: Jun. 21, 2023

(30) Foreign Application Priority Data
Dec. 21, 2020 (DE) 102020134487.2

(51) Int. Cl. H01J 35/14; G01N 23/223; H01J 35/08

(52) U.S. Cl. CPC H01J 35/153; G01N 23/223; H01J 35/08

(57) ABSTRACT

The invention relates to an x-ray source (100; 100a; 100b; 100c), comprising an electron source (110) for providing electrons (e) in the form of an electron beam (es) and a target element (120), on which the electrons (e) of the electron beam (es) of the electron source (110) are able to impinge, and at least one deflection device (140) enabling the electron beam (es) to be deflected from a propagation direction produced by the electron source (110), wherein the at least one deflection device (140) is configured to deflect the electron beam (es) at least intermittently with a trajectory (180) incident on the target element (120), but outside a center of the target element (120) or a region (150) of the target element (120) on which the electron beam (es) is incident in the case of a propagation direction without deflection, or wherein the at least one deflection device (140) is configured to deflect the electron beam (es) at least intermittently in such a way that the electron beam (es) is not incident on the target element (120).

The invention relates to an X-ray source and a method for operating such an X-ray source.

An X-ray tube is known from WO 99/50882 A1 which has an electron source for providing electrons in the form of an electron beam and a target material which can be impinged upon with electrons of the electron beam of the electron source. This X-ray source comprises at least one deflection device through which the electrons of the electron beam can be deflected within a region of the target element. A control grid which has a central through-opening for the electron beam is provided between the electron source and the target element. This control grid enables the electron beam to be modulated so that it can be switched off. However, on account of the central opening of the control grid, the electron beam continues to reach the target element.

The invention sets out to propose an X-ray source and an operating method for such an X-ray source which enables improved operation, in particular including during brief interruptions.

This aim is achieved by an X-ray source with an electron source for the provision of electrons in the form of an electron beam and a target element which can be impinged upon with the electrons of the electron beam and with at least one deflection device through which the electron beam can be deflected from a direction of propagation generated by the electron source, in which, according to a first alternative embodiment, the deflection device is configured to deflect the electron beam at least intermittently to the target element outside a centre of the target element or to deflect it to the target element outside an impact region which the electron beam would be incident on in the case of a direction of propagation without deflection. This enables the load of the target element to be reduced in the direction of propagation of the electron beam generated by the electron without deflection in standby operation or when operation of the X-ray source is interrupted. This makes it possible for the target element to continue to be thermally loaded by the incident electron beam such that, during a brief interruption of the operation of the X-ray source or in what is referred to as a standby status, the temperature of the carrier element or of the anode body is not cooled or is only partially cooled, but not completely such that thermal drift of the target element is avoided in a following operation.

According to a further alternative, this aim is achieved by an X-ray source in which the at least one deflection device is configured to deflect the electron beam at least intermittently such that the electron beam is not incident on the target element. Like the first alternative, this configuration has the advantage that, during a brief interruption of the operation of the X-ray tube or in standby mode, the load of the target material can be reduced.

Through the at least one deflection device, the electron beam with a trajectory according to an Archimedean spiral may be controllable. The trajectory along this Archimedean spiral can be carried out from inside to outside or from outside to inside on the carrier element here. The trajectory may preferably be controlled such that the latter is not incident on the centre of the target element or an impact region of the electron beam which lies in the direction of propagation of the electron beam of the electron source without deflection.

In a further exemplary embodiment, provision is made for the electron source to be configured to impinge upon different regions of the target element with the electrons sequentially in time, for example in the form of a or the electron beam. In other words, in further exemplary embodiments, the different regions of the target element with their different target materials may be impinged upon with the electrons or the electron beam, for example, in a time-division multiplexing method.

In further exemplary embodiments, provision is made for the X-ray source to have at least one deflection device for the at least intermittent deflection of the electrons, for example of a or the electron beam. In further exemplary embodiments, the deflection device may, for example, be configured to generate at least intermittently at least one electrical and/or magnetic field for the deflection of the electrons.

Provision is preferably furthermore made for a catching device for the deflected electron beam to be provided outside the target element, in particular viewed radially outside the target element. This catching device has the advantage that a load of a glass body of the X-ray source, which preferably surrounds the electron source and the target element and is impinged upon with a vacuum, can be reduced. This catching device may extend only partially or also completely around the target element. Provision may also be made for this catching device to consist of a plurality of segments which are positioned at a distance from one another outside the region of the target element.

This catching device is preferably thermally coupled to the target element and/or the anode body. As a result, the energy from the braking radiation or the electron beam which arises in the catching device may be converted into thermal energy and transferred to the target element and/or the anode body. A cooling of the anode body and/or the target layer can be prevented, in particular during a brief interruption of the operation of the X-ray tube. This enables a thermal drift thereof to be prevented.

Exemplary embodiments relate to an X-ray source having an electron source for providing electrons and a target element upon which the electrons are able to impinge, wherein the target element has a first region with a first target material and a second region with a second target material which is different from the first target material. This enables flexible operation which, for example, enables the generation of different types of X-radiation, that is to say with different properties, for example based on the respective target material.

In further exemplary embodiments, provision is made for the target material to include at least one of the following elements: a) tungsten, b) molybdenum, c) rhodium, d) chromium. Other elements or materials which may generate X-radiation in the event of impingement with electrons, for example in the form of an electron beam, can also be used for at least one region of the target element in further exemplary embodiments.

In further exemplary embodiments, the electron source is configured to provide the electrons based on the principle of thermionic emission and/or of field emission.

In further exemplary embodiments, the X-ray source has an anode body, wherein the anode body, for example, includes copper or is made of copper.

In further exemplary embodiments, an acceleration voltage, for example for accelerating the electrons provided by the electron source, for example in the direction of the anode body or of the target element, may be applied between a component of the electron source, for example a coiled filament, and the anode body. When the accelerated electrons or an electron beam formed by them in further exemplary embodiments is incident on the target element, the electrons are slowed down by the target material, as a result of which X-radiation can be generated. Depending on the region of the target element or based on the target material to be found in the region of the target element, the X-radiation has different properties such as, for example, an intensity and/or a spectrum.

In further exemplary embodiments, provision is made for the target element to be arranged on the anode body, for example on at least one surface of the anode body.

In further exemplary embodiments, provision is made for the corresponding first and/or second target material to be arranged in the first region and/or in the second region in the form of a layer. In other words, in further exemplary embodiments, the first target material is arranged in the first region of the target element in the form of a layer and/or, in further exemplary embodiments, the second target material is arranged in the second region of the target element in the form of a layer.

In further exemplary embodiments, provision is made for a or the layer made from the first target material and/or a or the layer made from the second target material to be arranged on the anode body, for example on the at least one surface of the anode body.

In further exemplary embodiments, provision is made for the first region and/or the second region, for example, to be, at least approximately, of at least one of the following shapes: a) semicircular shape, b) circular shape, c) circular ring shape, d) sector shape.

In further exemplary embodiments, provision is made for the first region and the second region each to be, for example at least approximately, of semicircular shape. In further exemplary embodiments, provision is made for the two at least approximately semicircular regions to be arranged with their bottom sides (which are, for example, essentially straight, for example corresponding to a diameter of the semicircular shape) facing one another such that the two regions together form, for example, an at least approximately circular region.

In further exemplary embodiments, provision is made for the first region to be of circular shape or circular ring shape, wherein the second region is of circular shape or circular ring shape, wherein, for example, the second region is arranged concentrically to the first region. By way of example, in further exemplary embodiments, the first region may be of circular ring shape, and the second region is likewise of circular ring shape or circular shape and is, for example, arranged radially within the first region, for example directly adjoining an inner contour of the first region.

In further exemplary embodiments, provision is made for at least one further region with a further, for example third, target material to be provided, wherein the third target material is different from the first and/or second target material.

In further exemplary embodiments, provision may be made for more than three regions with, if applicable, further target materials, for example differing from one another.

In further exemplary embodiments, the target element is arranged statically with respect to the electron source.

In further exemplary embodiments, provision is made for the electron source to be configured, for example, optionally, to impinge upon the first region and/or the second region of the target element with the electrons, for example in the form of a or the electron beam.

In further exemplary embodiments, provision is made for the at least one deflection device to be configured to deflect the electrons at least intermittently such that they are, for example only, incident on the target element in the first region or in the second region. As a result, X-radiation of a type corresponding to the respective target material of the selected region may be generated, for example optionally.

In further exemplary embodiments, provision is made for the deflection device to generate, for example, at least intermittently, at least one electrical field which includes, at least regionally, field components which are orthogonal to a direction of propagation of the electrons, for example corresponding to a longitudinal axis or parallel to a longitudinal axis of the X-ray source. In further exemplary embodiments, this may be carried out for a deflection along a first dimension or spatial direction and/or for a deflection along a second dimension or spatial direction.

In further exemplary embodiments, provision is made for the at least one deflection device to have a deflection stage or a plurality of deflection stages.

In further exemplary embodiments, provision is made, in the case of a plurality of deflection stages, for these to be arranged, for example, along a direction of propagation of the electrons, for example towards the target element, or along a longitudinal axis of the X-ray source. In further exemplary embodiments, provision is made, in the case of a plurality of deflection stages, for these to be arranged along a circumferential direction of the electron beam. In further exemplary embodiments, combinations of the two abovementioned arrangement variants are likewise possible.

In further exemplary embodiments, provision is made, in the case of a plurality of deflection stages, for these, for example, to be used to shift a or the electron beam, for example at least approximately parallel to its initial orientation defined by the electron source. In further exemplary embodiments, for example, this can be brought about by the electron beam being deflected by a first deflection stage by a specifiable first degree (for example characterizable by a first angle) with respect to its initial orientation, and by the electron beam that has been deflected in this way being deflected by a second deflection stage, for example arranged downstream of the first deflection stage, by a specifiable second degree (for example characterizable by a second angle), for example in the opposite direction, such that, after the second deflection, the electron beam is, for example, at least approximately parallel to the initial orientation (angular deviations of +10° to −10° with respect to the initial orientation are permissible).

In further exemplary embodiments, provision is made for the at least one deflection device to be configured to compensate for stray fields, for example external stray fields. In further exemplary embodiments, for example, at least one variable may be established which characterizes such a stray field and, based on the at least one variable, in further exemplary embodiments, the at least one deflection device may be controlled or the controlling of the at least one deflection device may be influenced such that the stray field is at least partially compensated for. As a result, in further exemplary embodiments, for example, environmental influences in regionally or globally different places of use may also be reduced or compensated for.

In further exemplary embodiments, provision is made for the at least one deflection device to have at least two differently configured deflection stages, for example arranged orthogonally to one another.

In further exemplary embodiments, provision is made for the deflection device to be configured to deflect the electrons sequentially in time to different regions of the target element, for example in two dimensions, for example to smear the electron beam over the different regions of the target element, for example in order to reduce an average local thermal load of the target element in the various regions.

In further exemplary embodiments, provision is made for the at least one deflection device to be configured to deflect the electrons at least intermittently such that they are not incident on the target element, for example pass radially outside the target element. As a result, the generation of X-radiation may be at least intermittently interrupted or minimized, this being useful in further exemplary embodiments, for example, for controlling a temperature of the target element.

In further exemplary embodiments, provision is made for the X-ray source to be configured to establish, at least intermittently, a first variable which characterizes a voltage applied between two electrodes of the deflection device. By way of example, the first variable is generated through the electron beam, for example depending on its position relative to the deflection device. Based on this first variable, in further exemplary embodiments, for example, conclusions may be drawn regarding a position of the electron beam (“beam position”), for example with respect to an initial orientation. By way of example, based on the first variable, the presence of a, for example external, stray field or interference field may also be established.

Further exemplary embodiments relate to an X-ray tube, for example for X-ray fluorescence analysis or X-ray fluorescence spectroscopy, with at least one X-ray source according to the embodiments.

X-ray fluorescence analysis is a non-destructive method of qualitative and/or quantitative material analysis. It is based on the principle that, by irradiating a material sample with polychromatic X-radiation, electrons are released from the inner shells of the atoms of the material sample. As a result, electrons from higher energy levels of the atoms may fall back to the lower energy levels corresponding to the inner shells, wherein fluorescence radiation specific to the material sample or its atoms is produced which, for example, can be recorded by a detector and provides information about the elemental composition of the material sample.

In further exemplary embodiments, X-ray fluorescence analysis of a material sample is carried out using the X-ray tube according to the present embodiments.

In further exemplary embodiments, X-ray fluorescence analysis using the X-ray tube according to the present embodiments is used to measure layer thickness, for example of thin layers and layer systems.

The aim underlying the invention is furthermore achieved by a method for operating an X-ray source with an electron source for providing electrons in the form of an electron beam and a target element which is impinged upon with the electrons of the electron beam and with at least one deflection device through which the electron beam of the electron source can be deflected in the direction of propagation, wherein, according to a first alternative, the at least one deflection device is controlled such that the electron beam is at least intermittently deflected with a trajectory to the target element, wherein this trajectory lies outside the centre of the target element or outside an impact region on the target element upon which the electron beam of the electron source is incident in the direction of propagation, in particular without deflection. As a result, the load of the target material in the centre or in the impact region can be reduced, in particular during an only brief interruption of the operation of the X-ray source or in standby mode.

According to an alternative configuration of this method, provision is made for the at least one deflection device to be controlled such that the electron beam at least intermittently is not incident on the target element.

In a preferred configuration of the method, provision is made for the at least one deflection device to be controlled with at least one diversion device. At least two deflection devices are controlled in order to control the electron beam with a trajectory according to an Archimedean spiral on the target element. When two deflection devices are used, these are preferably aligned orthogonally to one another. This trajectory enables equal loading of the target element outside the centre and, in particular, avoids any cooling of the target element during a brief interruption of the operation to generate X-rays.

Alternatively, provision is preferably made for the deflection device to be controlled such that the electron beam is incident on a catching device for the electron beam outside the target element. This catching device is preferably coupled to the target element and/or the anode body so as to enable a transfer of the thermal energy from the catching device to the target element and/or anode body at least regionally.

Further exemplary embodiments relate to a method for operating an X-ray source, having an electron source for providing electrons and a target element which can be impinged upon with the electrons, wherein the target element has a first region with a first target material and a second region with a second target material which is different from the first target material, wherein the method includes: for example, optionally, impinging upon the first region and/or the second region of the target element with the electrons, for example in the form of an electron beam.

In further exemplary embodiments, provision is made for the impinging to include: impinging upon different regions of the target element with the electrons sequentially in time, for example in the form of a or the electron beam.

In further exemplary embodiments, provision is made for the X-ray source to have at least one deflection device for the at least intermittent deflection of the electrons, wherein the method includes at least one of the following elements: a) at least intermittent deflection of the electrons by means of the at least one deflection device to the first region of the target element, for example such that the electrons are predominantly, for example only, incident on the first region, b) at least intermittent deflection of the electrons by means of the at least one deflection device to the second region of the target element, for example such that the electrons are predominantly, for example only, incident on the second region, c) at least intermittent deflection of the electrons by means of the at least one deflection device to at least one further region of the target element which is different from the first region and from the second region, for example such that the electrons are predominantly, for example only, incident on the at least one further region, d) at least intermittent deflection of the electrons by means of the at least one deflection device such that the electrons, for example a predominant number of the electrons, are not incident on the target element, for example pass radially outside the target element, e) deflection of the electrons sequentially to different regions of the target element, for example in one or two dimensions.

In further exemplary embodiments, provision is made for the method further to include: optionally, establishing information associated with a, for example external, stray field, for example having a field strength and/or direction, and at least intermittent and/or regional compensating for the stray field by means of at least one deflection device or the at least one deflection device

In further exemplary embodiments, provision is made for the method further to include: Establishing a first variable which characterizes a voltage applied between two electrodes of the deflection device, and, optionally, operating the X-ray source, for example the at least one deflection device, based on the first variable.

In further exemplary embodiments, provision is made for the two electrodes to be impinged upon, at least intermittently, for example in a first time domain, with a control voltage to deflect the electrons, wherein the first variable is established at least intermittently, for example in a second time domain which lies outside the first time domain.

In further exemplary embodiments, the first variable may be established by means of electrodes of a first deflection device, and at least one further deflection device may be used, for example simultaneously to establishing the first variable or at least temporally overlapping the establishing of the first variable, to deflect the electron beam, for example for the purposes of compensating for the stray field, for example based on the first variable.

In further exemplary embodiments, an operation of the X-ray source can therefore, for example, also be regulated, for example for the purposes of closed-loop regulation, wherein, for example, the first variable is established and controlling of at least one deflection stage which can be used to deflect the electron beam is controlled or operated based on, for example, inter alia, the first variable.

Further exemplary embodiments relate to an apparatus for controlling an X-ray source, in particular according to the embodiments, wherein the apparatus is configured to carry out the method according to the embodiments.

Further exemplary embodiments relate to a computer-readable storage medium comprising commands which, when carried out by a computer, cause the latter to carry out the method according to the embodiments.

Further exemplary embodiments relate to a computer program comprising commands which, when the program is carried out by a computer, cause the latter to carry out the method according to the embodiments.

Further exemplary embodiments relate to a data carrier signal which transmits and/or characterizes the computer program according to the embodiments.

Further exemplary embodiments relate to a use of the X-ray source according to the embodiments and/or of the X-ray tube according to the embodiments and/or of the method according to the embodiments and/or of the apparatus according to the embodiments and/or of the computer-readable storage medium according to the embodiments and/or of the computer program according to the embodiments and/or of the data carrier signal according to the embodiments for at least one of the following elements: a) providing different types of X-radiation which differ from one another, for example, in terms of their intensity and/or their spectrum, for example providing at least two different types of X-radiation sequentially in time and/or alternatingly, b) optimizing the X-ray source and/or a or the X-ray tube for a specifiable application, for example in the area of X-ray fluorescence analysis, c) carrying out X-ray fluorescence analysis, d) controlling, for example reducing, a thermal load of the target element, for example in an axis region, e) increasing a service life or durability of the target element, for example for precise applications, f) reducing, for example interrupting, a generation of X-radiation, g) making individual use of at least one region of the target element, h) compensating for stray fields or interference fields, for example external stray fields or interference fields, i) smearing the electrons or the electron beam on the target element, j) evaluating a beam position of a or the electron beam, for example carrying out a diagnosis.

Further features, possible applications and advantages of exemplary embodiments are provided in the following description of exemplary embodiments which are shown in the figures of the drawings. All of the features described or depicted per se or in any desired combination form the subject matter of exemplary embodiments, irrespective of their summary in the claims or their referral back and irrespective of their wording and depiction in the description and in the drawings respectively.

In the drawings:

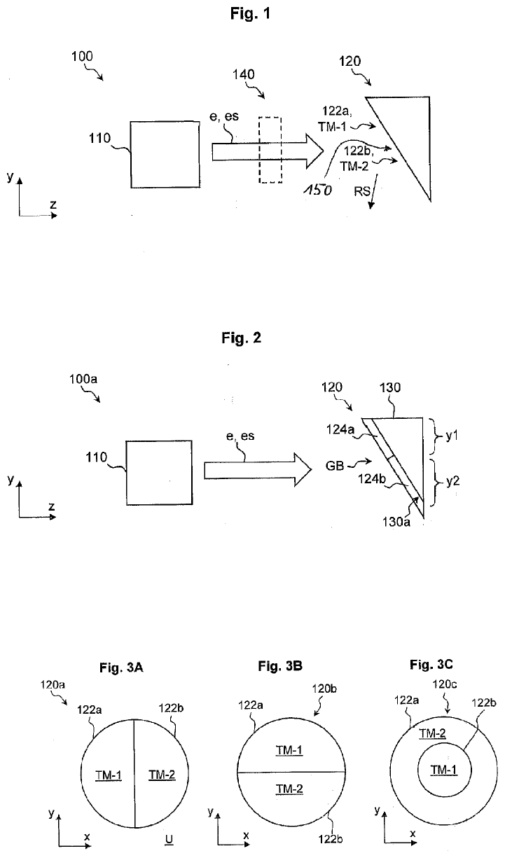

FIG. 1 schematically shows a simplified block diagram according to exemplary embodiments,

FIG. 2 schematically shows a simplified block diagram according to further exemplary embodiments,

FIGS. 3A, 3B and 3C each schematically show a plan view of a target element according to further exemplary embodiments,

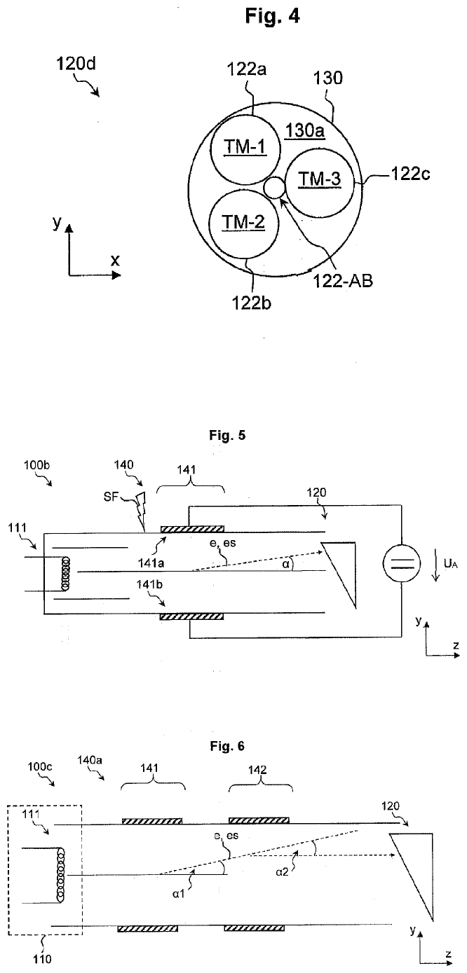

FIG. 4 schematically shows a plan view of a target element according to further exemplary embodiments,

FIG. 5 schematically shows a side view of an X-ray source according to further exemplary embodiments,

FIG. 6 schematically shows a side view of an X-ray source according to further exemplary embodiments,

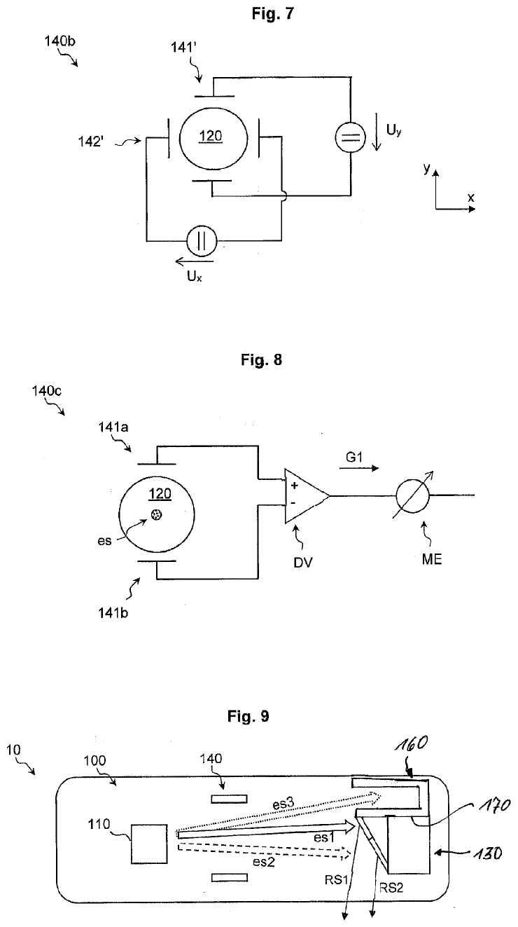

FIG. 7 schematically shows aspects of a deflection device according to further exemplary embodiments,

FIG. 8 schematically shows aspects of a deflection device according to further exemplary embodiments,

FIG. 9 schematically shows a simplified block diagram according to further exemplary embodiments,

FIG. 10 schematically shows a plan view of a target element with a beam guidance of an electron beam,

FIG. 11 schematically shows a simplified flow diagram of methods according to further exemplary embodiments,

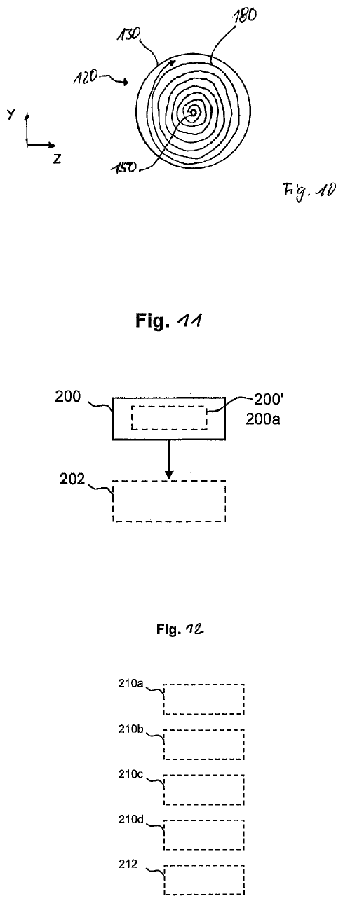

FIG. 12 schematically shows a simplified flow diagram of methods according to further exemplary embodiments,

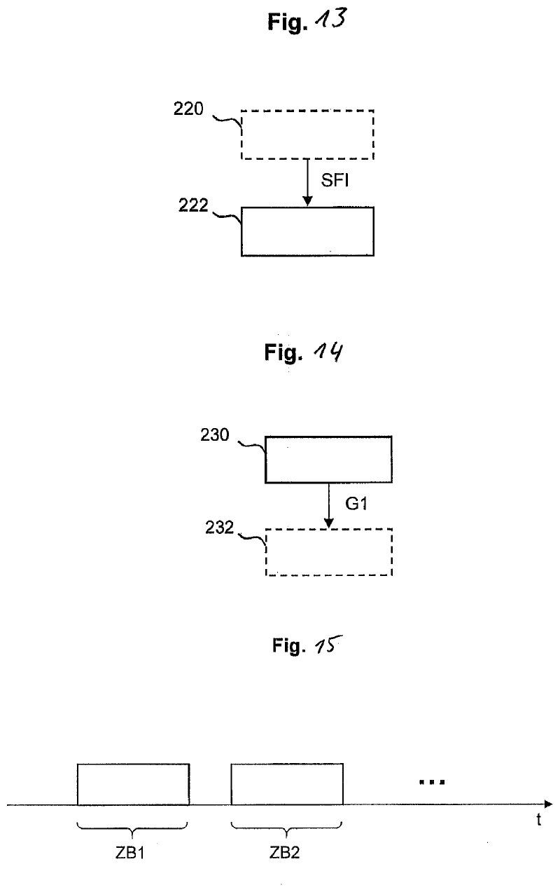

FIGS. 13 and 14 each schematically show a simplified flow diagram of methods according to further exemplary embodiments,

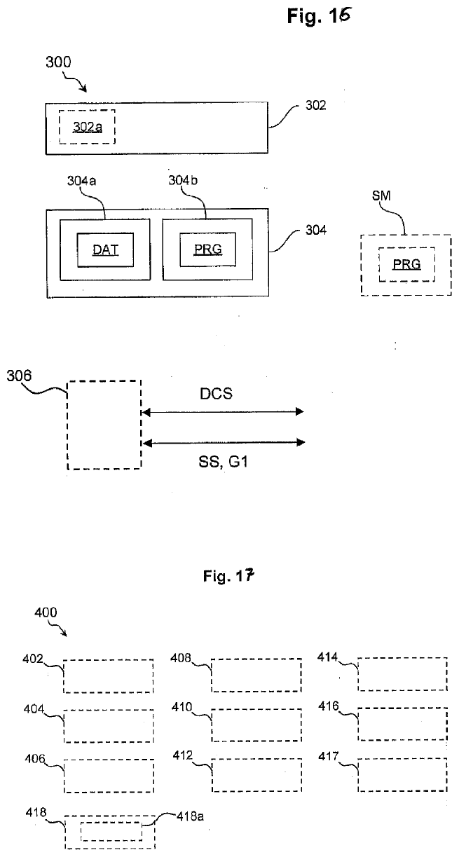

FIG. 15 schematically shows a time diagram according to further exemplary embodiments,

FIG. 16 schematically shows a simplified block diagram according to further exemplary embodiments, and

FIG. 17 schematically shows aspects of uses according to further exemplary embodiments.

Exemplary embodiments, cf. FIG. 1, relate to an X-ray source 100, having an electron source 110 for providing electrons e, for example in the form of an electron beam es, and a target element 120 which can be impinged upon with the electrons e.

An exemplary direction of propagation of the electrons e or of the electron beam is provided symbolically in FIG. 1 through a spatial direction corresponding to the Z-axis z (or a parallel thereto). A spatial direction orthogonal to the exemplary direction of propagation z is indicated by the y-axis y configured vertically by way of example in FIG. 1.

The electron beam es generated by the electron source 110 is incident on the target element 120 in an impact region 150 when the electron beam es is in its direction of propagation without deflection. This impact region 150 may lie in the centre of the target element 120 or else outside it. This is determined by the alignment of the electron source 110 with the target element 120.

The target element 120 has a first region 122a with a first target material TM-1 and a second region 122b with a second target material TM2 which is different from the first target material TM-1. This enables flexible operation which, for example, enables the generation of different types of X-radiation RS, that is to say with different properties, for example based on the respective target material TM-1, TM-2.

In further exemplary embodiments, provision is made for the target material TM-1, TM-2 to include at least one of the following elements: a) tungsten, b) molybdenum, c) rhodium, d) chromium. Other elements or materials which may generate X-radiation RS in the event of impingement with electrons e, for example in the form of the electron beam es, can also be used for at least one region 122a, 122b of the target element 120 in further exemplary embodiments.

In further exemplary embodiments, the electron source 110 is configured to provide the electrons e based on the principle of thermionic emission and/or of field emission. By way of example, for this purpose, the electron source 110 may have a coiled filament 111 (not shown in FIG. 1), see also, for example, FIG. 5.

In further exemplary embodiments, FIG. 2, the X-ray source 100a has an anode body 130, wherein the anode body 130, for example, includes copper or is made of copper.

In further exemplary embodiments, an acceleration voltage (not depicted for reasons of clarity) may be applied, for example, to accelerate the electrons e provided by the electron source 110, for example in the direction of the anode body 130 or of the target element 120, that is to say, for example, at least approximately parallel to the z-axis in FIGS. 1 and 2, between a component of the electron source 110, for example the coiled filament 111 (FIG. 5), and the anode body 130 (FIG. 2). When the accelerated electrons e or the electron beam es formed by them are incident on the target element 120, the electrons e are slowed down by the target material TM-1, TM-2, as a result of which X-radiation RS (FIG. 1) can be generated. Depending on the region 122a, 122b of the target element 120 or based on the target material TM-1, TM-2 to be found in the region 122a, 122b of the target element 120, the X-radiation RS has different properties such as, for example, an intensity and/or a spectrum.

In further exemplary embodiments, FIG. 2, provision is made for the target element 120 to be arranged on the anode body 130, for example on at least one surface 130a of the anode body 130.

In further exemplary embodiments, provision is made for the corresponding first and/or second target material TM-1, TM-2 to be arranged in the form of a layer 124a, 124b in the first region 122a (FIG. 1) which, for example, corresponds to a first y-coordinate range y1 according to FIG. 2, and/or in the second region 122b (FIG. 1) which, for example, corresponds to a second y-coordinate range y2 according to FIG. 2. In other words, in further exemplary embodiments, the first target material TM-1 is arranged in the first region 122a of the target element 120 in the form of a layer 124a and/or, in further exemplary embodiments, the second target material TM-2 is arranged in the second region 122b of the target element 120 in the form of a second layer 124b.

In further exemplary embodiments, the different regions 122a, 122b or layers 124a, 124b with their different target materials TM-1, TM-2 may, for example, be ascribed to different vertical coordinate ranges y1, y2 in FIGS. 1 and 2, for example of the surface 130a, such that, for example, through a corresponding deflection of the electron beam es, either the first region 122a and/or the second region 122b can be impinged upon.

In further exemplary embodiments, the electron beam es may, for example, at least intermittently, also be deflected or directed, for example to a boundary region GB of the two regions 122a, 122b (for example running perpendicularly to the plane of the drawing in FIG. 2) such that both regions 122a, 122b are simultaneously impinged upon with the electron beam es.

In further exemplary embodiments, provision is made for a or the layer 124a made from the first target material TM-1 and/or a or the layer 124b made from the second target material TM-2 to be arranged on the anode body 130, for example on the at least one surface 130a of the anode body 130.

In further exemplary embodiments, cf. FIGS. 3A, 3B and 3C, provision is made for the first region 122a and/or the second region 122b, for example, to be, at least approximately, at least one of the following shapes: a) semicircular shape, b) circular shape, c) circular ring shape, d) sector shape.

By way of example, FIG. 3A shows a schematic plan view of a target element 120a with two semicircular regions 122a, 122b arranged next to one another along an x-axis in FIG. 3A, each with a different target material TM-1, TM-2.

By way of example, FIG. 3B shows a schematic plan view of a target element 120b with two semicircular regions 122a, 122b arranged next to one another along the y-axis in FIG. 3B, each with a different target material TM-1, TM-2.

In further exemplary embodiments, cf. FIGS. 3A and 3B, provision is made for the two at least approximately semicircular regions 122a, 122b to be arranged with their bottom sides (which are, for example, essentially straight, for example corresponding to a diameter of the semicircular shape) facing one another such that the two regions 122a, 122b together form, for example, an at least approximately circular region which, in further exemplary embodiments, for example, may cover the entire surface 130a (FIG. 2).

In further exemplary embodiments 120c, FIG. 3C, provision is made for the first region 122a to be of circular shape or circular ring shape, wherein the second region 122b is of circular shape or circular ring shape, wherein, for example, the second region is arranged concentrically to the first region. By way of example, in further exemplary embodiments, the first region 122a may be of circular ring shape, and the second region 122b is likewise of circular ring shape or circular shape and is, for example, arranged radially within the first region 122a, for example directly adjoining an inner contour of the first region 122a.

In further exemplary embodiments, cf. the target element 120d from FIG. 4, provision is made for at least one further region 122c with a further, for example third, target material TM-3 to be provided, wherein the third target material TM-3 is different from the first and/or second target material.

In further exemplary embodiments, provision may be made for more than three regions 122a, 122b, 122c (not shown) with, if applicable, further target materials, for example differing from one another.

In further exemplary embodiments, the target element 120, 120a, 120b, 120c, 120d is arranged statically with respect to the electron source.

In further exemplary embodiments, FIG. 2, provision is made for the electron source 110 to be configured, for example, optionally, to impinge upon the first region 122a and/or the second region 122b of the target element 120 with the electrons e, for example in the form of the electron beam es.

In further exemplary embodiments, provision is made for the electron source 110 to be configured to impinge upon different regions 122a, 122b, 122c of the target element 120 sequentially in time with the electrons e, for example in the form of the electron beam es. In other words, in further exemplary embodiments, the different regions 122a, 122b, 122c of the target element 120 with their different target materials TM-1, TM-2, etc. may be impinged upon with the electrons e or the electron beam es, for example, in a time-division multiplexing method.

In further exemplary embodiments, cf. FIG. 5, provision is made for the X-ray source 100b to have at least one deflection device 140 for the at least intermittent deflection of the electrons e, for example of the electron beam es. In further exemplary embodiments, the deflection device 140 may, for example, be configured to generate at least intermittently at least one electrical and/or magnetic field for the deflection of the electrons e.

In further exemplary embodiments, provision is made for the at least one deflection device 140 to be configured to deflect the electrons e at least intermittently such that they are, for example only, incident on the target element 120 in the first region 122a (FIG. 1) or in the second region 122b. As a result, X-radiation RS of a type corresponding to the respective target material TM-1, TM2 of the selected region 122a, 122b may be generated, for example optionally.

In further exemplary embodiments, provision is made for the deflection device 140 to generate, for example, at least intermittently, at least one electrical field which includes, at least regionally, field components which are orthogonal to a direction of propagation z (FIG. 5) of the electrons e, for example corresponding to a longitudinal axis or parallel to a longitudinal axis of the X-ray source 100b. In further exemplary embodiments, this may be carried out for a deflection along a first dimension or spatial direction y and/or for a deflection along a second dimension or spatial direction, for example perpendicularly to the plane of the drawing in FIG. 5.

In further exemplary embodiments, provision is made for the at least one deflection device 140 to have a deflection stage 141 (FIG. 5) or a plurality of deflection stages 141, 142, cf. the deflection device 140a according to FIG. 6.

By way of example, in further exemplary embodiments, a first voltage U A may be applied at least intermittently to the electrodes 141a, 141b of the deflection stage 141 from FIG. 5 in order to generate said electrical field with field components along the y-axis.

In further exemplary embodiments, cf. the X-ray source 100c according to FIG. 6, provision is made, in the case of a plurality of deflection stages 141, 142, for these to be arranged, for example, along a direction of propagation z of the electrons e, for example towards the target element 120.

In further exemplary embodiments, cf. the deflection unit 140b from FIG. 7, provision is made, in the case of a plurality of deflection stages 141′, 142′, for these to be arranged along a circumferential direction of the electron beam.

In further exemplary embodiments, combinations of the two abovementioned arrangement variants are likewise possible.

In further exemplary embodiments, FIG. 6, provision is made, in the case of a plurality of deflection stages 141, 142, for these to be used, for example, to shift the electron beam es, for example at least approximately parallel with respect to its initial orientation defined by the electron source 110 (for example horizontally to the right in FIG. 6). In further exemplary embodiments, for example, this can be brought about by the electron beam es being deflected by a first deflection stage 141 by a specifiable first degree (for example characterizable by a first angle α1) with respect to its initial orientation, and by the electron beam that has been deflected in this way being deflected by a second deflection stage 142, for example arranged downstream of the first deflection stage 141, by a specifiable second degree (for example characterizable by a second angle α2), for example in the opposite direction, such that, after the second deflection, the electron beam is, for example, at least approximately parallel to the initial orientation (angular deviations of +10° to −10° with respect to the initial orientation are permissible). In further exemplary embodiments, for example, α2=−α1.

In further exemplary embodiments, cf. FIG. 5, provision is made for the at least one deflection device 140 to be configured to compensate for stray fields SF, for example external stray fields SE In further exemplary embodiments, for example, at least one variable may be established which characterizes such a stray field SF and, based on the at least one variable, in further exemplary embodiments, the at least one deflection device 140 may be controlled or the controlling of the at least one deflection device 140 may be influenced such that the stray field SF is at least partially compensated for. As a result, in further exemplary embodiments, for example, environmental influences in regionally or globally different places of use may also be reduced or compensated for.

In further exemplary embodiments, FIG. 7, provision is made for the at least one deflection device 140b to have at least two differently configured deflection stages 141′, 142′, for example arranged orthogonally to one another. As a result, in further exemplary embodiments, for example, any desired Cartesian point on the target element 120 can be addressed, that is to say impinged upon with the electron beam es, for example corresponding to a point in the x-y plane here. For this purpose, in further exemplary embodiments, the electrodes of the deflection stages 141′, 142′ are controlled with corresponding control or deflection voltages Ux, Uy.

In further exemplary embodiments, provision is made for the deflection device 140, 140a, 140b to be configured to deflect the electrons e sequentially in time to different regions 122a, 122b of the target element 120, for example in two dimensions x, y (FIG. 7), for example to smear the electron beam es over the different regions 122a, 122b of the target element 120 (for example by wobbling the deflection voltages Ux, Uy), for example in order to reduce an average local thermal load of the target element 120 in the various regions 122a, 122b. In further exemplary embodiments, such smearing may, for example, be carried out for a stand-by mode in which the X-radiation is not used for measurements, but the target element 120 is supposed to be spared.

In further exemplary embodiments, a beam current of the electron beam es may be varied, wherein, for example, it may be reduced for the optional stand-by mode, and wherein it may be increased for a measurement mode, for example, with respect to the stand-by mode.

In further exemplary embodiments, provision is made for the at least one deflection device 140, 140a, 140b to be configured to deflect the electrons at least intermittently such that they are not incident on the target element 120 (FIG. 7), for example pass radially outside the target element 120, wherein, for example, they reach a surrounding area U (FIG. 3A) of the target element 120. As a result, the generation of X-radiation may be at least intermittently interrupted or minimized, this being useful in further exemplary embodiments, for example, for controlling a temperature of the target element 120.

In further exemplary embodiments, FIG. 8, provision is made for the X-ray source to be configured to establish, at least intermittently, a first variable G1 which characterizes a voltage applied between two electrodes 141a, 141b of the deflection device 140c. By way of example, the first variable G1 is generated through the electron beam es, for example depending on its position relative to the deflection device 140c. Based on this first variable G1, in further exemplary embodiments, for example, conclusions may be drawn regarding a position of the electron beam es (“beam position”), for example with respect to an initial orientation. By way of example, based on the first variable G1, the presence of a, for example external, stray field or interference field SF may also be established (FIG. 5).

In further exemplary embodiments, for example, a difference amplifier or operational amplifier DV or some other amplification device may be provided to establish the first variable G1. Optionally, provision may also be made for a measuring device ME which detects the first variable G1 metrologically and, for example, supplies it to an analogue input of a control device.

Further exemplary embodiments, FIG. 9, relate to an X-ray tube 10, for example for X-ray fluorescence analysis or X-ray fluorescence spectroscopy, with at least one X-ray source 100 according to the embodiments.

It can be seen from FIG. 9 that X-radiation RS1 of the first type or X-radiation RS2 of the second type may optionally be generated by means of the X-ray tube 10 or the X-ray source 100, for example, by one of the regions 122a,122b (FIG. 1) of the target element 120 being impinged upon with the electron beam es (FIG. 1).

The block arrow est according to FIG. 9 symbolizes an operational status in which the electron beam es, by way of example, is directed at the first region 122a of the target element 120 with the first target material TM-1, wherein the X-radiation RS1 of the first type is generated, whereas the dotted block arrow est symbolizes an operational status in which the electron beam, by way of example, is directed at the second region 122b of the target element 120 with the second target material TM-2, wherein the X-radiation RS2 of the second type is generated.

The block arrow es3 according to FIG. 9 symbolizes a further operational status in which the electron beam es is deflected such that it is not incident on the target element 120, as a result of which the generation of X-radiation is deactivated or minimized.

In the embodiment of the X-ray tube 10 according to FIG. 9, provision may preferably also be made for a catching device 160. This catching device 160 serves to reduce the emitted braking X-radiation. This catching device 160 may extend only partially around the target element 120. Alternatively, the catching element 160 may also extend along the entire outer circumference of the target element 120. A plurality of catching devices 160 may also be configured to be distributed at a distance from one another over the circumference of the target element 120.

Advantageously, the catching device 160 is thermally coupled to the target element 120 and/or the anode body 130. An interface 170 for the thermal coupling may extend at least partially or completely between the catching device 160 and the target element 120 and/or the anode body 130.

In further exemplary embodiments, X-ray fluorescence analysis of a material sample (not shown) is carried out using the X-ray tube 10 according to the present embodiments.

In further exemplary embodiments, X-ray fluorescence analysis using the X-ray tube 10 according to the present embodiments is used to measure layer thickness, for example of thin layers and layer systems.

The controlling and deflection of the electron beam es, according to the X-ray source 100, in particular in the case of the X-ray tube 10 according to FIG. 9, may also be carried out such that, instead of the electron beam es3 and the electron beam est, the electron beam es1 which corresponds to the electron beam es is controlled with a trajectory 180 such that the target element 120 is struck, but not the centre of the target element 120 or an impact region 150 of the target element 120. These are not crossed by the at least one deflection device 140 in the controlled trajectory 180 of the electron beam es1. This impact region 150 on the target element 120 may be the region of the electron beam es which lies in a direction of propagation of the electron beam es generated by the electron source 110 and is not deflected, in other words the electron beam es generated by the electron source 110 is incident on the impact region 150 in its direction of propagation without experiencing any deflection. The controlled trajectory 110 of the electron beam es1 may correspond to that of an Archimedean spiral. The trajectory 110 may be from outside to inside or from inside to outside here. Alternatively, a free form of a trajectory within the region of the target element 120 may also be controllable by the at least one deflection device 140 without crossing the impact region 150. A free form of the trajectory may be understood to mean any desired path deviating from the trajectory according to the Archimedean spiral.

Further exemplary embodiments, FIG. 11, relate to a method for operating an X-ray source 100 (FIG. 1), having an electron source 110 for providing electrons e and a target element 120 which can be impinged upon with the electrons e, wherein the target element 120 has a first region 122a with a first target material TM-1 and a second region 122b with a second target material TM-2 which is different from the first target material TM-1, wherein the method includes: for example, optionally, impinging 200 (FIG. 11) upon the first region 122a and/or the second region 122b of the target element 120 with the electrons e, for example in the form of an electron beam es.

In further exemplary embodiments, provision is made for the impinging 200 to include: impinging upon different regions 122a, 122b of the target element 120 with the electrons sequentially in time, for example in the form of a or the electron beam.

In further exemplary embodiments, provision is made for an optional step 202 which relates to a use of the X-radiation RS1, RS2 generated, if applicable, in step 200.

In further exemplary embodiments, FIG. 12, provision is made for the X-ray source to have at least one deflection device 140 for the at least intermittent deflection of the electrons e, wherein the method includes at least one of the following elements: a) at least intermittent deflection 210a of the electrons e by means of the at least one deflection device 140 to the first region 122a (FIG. 1) of the target element 120, for example such that the electrons are predominantly, for example only, incident on the first region 122a, b) at least intermittent deflection 210b (FIG. 12) of the electrons e by means of the at least one deflection device 140 to the second region 122b of the target element 120, for example such that the electrons e are predominantly, for example only, incident on the second region 122b, c) at least intermittent deflection 210c of the electrons e by means of the at least one deflection device 140 to at least one further region 122c (FIG. 4) of the target element 120d which is different from the first region 122a and from the second region 122b, for example such that the electrons e are predominantly, for example only, incident on the at least one further region 122c, d) at least intermittent deflection 210d of the electrons e by means of the at least one deflection device 140 such that the electrons, for example a predominant number of the electrons, are not incident on the target element 120, for example pass radially outside the target element 120, cf. reference numeral e3 according to FIG. 9, e) deflection 212 of the electrons e sequentially to different regions 122a, 122b of the target element 120, for example in one or two dimensions x, y (FIG. 7).

In further exemplary embodiments, FIG. 13, provision is made for the method further to include: optionally, establishing 220 information SFI associated with a, for example external, stray field SF, for example having a field strength and/or direction, and at least intermittent and/or regional compensating 222 for the stray field SF by means of the at least one deflection device 140.

In further exemplary embodiments, FIG. 14, provision is made for the method further to include: establishing 230 a first variable G1 which characterizes a voltage applied between two electrodes 141a, 141b (FIG. 8) of the deflection device 140c, and, optionally, operating 232 (FIG. 14) the X-ray source, for example the at least one deflection device 140, based on the first variable G1.

In further exemplary embodiments, FIG. 15, provision is made for the two electrodes 141a, 141b (FIG. 8) to be impinged upon, at least intermittently, for example in a first time domain ZB1 (FIG. 15), with a control voltage to deflect the electrons e, wherein the first variable G1 is established at least intermittently, for example in a second time domain ZB2 which lies outside the first time domain ZB1.

In further exemplary embodiments, the first variable G1 may be established by means of electrodes of a first deflection device 141 (FIG. 6), and at least one further deflection device 142 may be used, for example simultaneously to establishing the first variable G1 or at least temporally overlapping the establishing of the first variable G1, to deflect the electron beam es, for example for the purposes of compensating for the stray field SF, for example based on the first variable G1.

In further exemplary embodiments, an operation of the X-ray source can therefore, for example, also be regulated, for example for the purposes of closed-loop regulation, wherein, for example, the first variable G1 (FIG. 14) is established, cf. block 230, and controlling of at least one deflection stage 142 (FIG. 6) which can be used to deflect the electron beam es is controlled or operated based on, for example, inter alia, the first variable G1, cf. the optional block 232 according to FIG. 14.

Further exemplary embodiments, FIG. 16, relate to an apparatus 300 for controlling an X-ray source, in particular according to the embodiments, wherein the apparatus 300 is configured to carry out the method according to the embodiments.

The apparatus 300 has, for example: a computer 302 having at least one core 302a, a memory device 304 assigned to the computer 302 for the at least intermittent storage of at least one of the following elements: a) data DAT, b) computer program PRG, in particular for carrying out a method according to the embodiments.

In further preferred embodiments, the memory device 304 has a volatile memory 304a (for example random access memory (RAM)), and/or a non-volatile memory 304b (for example flash EEPROM).

In further exemplary embodiments, the computer 302 has at least one of the following elements or is configured as at least one of these elements: microprocessor (μP), micro-controller (μC), application-specific integrated circuit (ASIC), system on chip (SoC), programmable logic module (for example FPGA, field programmable gate array), hardware circuit, graphics processing unit (GPU), or any desired combinations thereof.

Further exemplary embodiments relate to a computer-readable storage medium SM comprising commands PRG which, when carried out by a computer 302, cause the latter to carry out the method according to the embodiments.

Further exemplary embodiments relate to a computer program PRG comprising commands which, when the program is carried out by a computer 302, cause the latter to carry out the method according to the embodiments.

Further exemplary embodiments relate to a data carrier signal DCS which characterizes and/or transmits the computer program PRG according to the embodiments. The data carrier signal DCS, for example, can be transmitted via an optional data interface 306 of the apparatus 300.

In further exemplary embodiments, the data interface 306 may be used to receive, for example, the first variable (FIG. 8) or a variable derived therefrom, and/or to emit control signals SS, for example for the at least one deflection device 140, 140a, 140b, 140c. Optionally, provision may be made for at least one amplification level (not shown) which converts the control signals SS into a correspondingly high deflection voltage.

Through the emitting of corresponding control signals SS, the apparatus 300 can, in further exemplary embodiments, for example, control which type of X-radiation RS1, RS2 is generated or at least intermittently deactivate the generation of X-radiation or compensate for any stray fields SD that may be present.

Further exemplary embodiments, FIG. 17, relate to a use 400 of the X-ray source 100, 100a, 100b, 100c according to the embodiments and/or of the X-ray tube 10 according to the embodiments and/or of the method according to the embodiments and/or of the apparatus 300 according to the embodiments and/or of the computer-readable storage medium SM according to the embodiments and/or of the computer program PRG according to the embodiments and/or of the data carrier signal DCS according to the embodiments for at least one of the following elements: a) providing 402 different types RS1, RS2 of X-radiation which differ from one another, for example, in terms of their intensity and/or their spectrum, for example providing at least two different types of X-radiation sequentially in time and/or alternatingly, b) optimizing 404 the X-ray source and/or a or the X-ray tube for a specifiable application, for example in the area of X-ray fluorescence analysis, c) carrying out 406 X-ray fluorescence analysis, d) controlling 408, for example reducing, a thermal load of the target element 120, for example in an axis region 122-AB (FIG. 4), e) increasing 410 (FIG. 17) a service life or durability of the target element 120, for example for precise applications, f) reducing 412, for example interrupting, a generation of X-radiation, g) making individual use 414 of at least one region 122a of the target element 120, h) compensating 416 for stray fields SF or interference fields, for example external stray fields SF or interference fields, i) smearing 417 the electrons e or the electron beam es on the target element 120, j) evaluating 418 a beam position of a or the electron beam es, for example carrying out 418a a diagnosis.

1. X-ray source, having an electron source for providing electrons in the form of an electron beam and a target element is able to be impinged upon with the electrons of the electron beam of the electron source, and at least one deflection device through which the electron beam can be deflected from a direction of propagation generated by the electron source,
wherein the at least one deflection device is configured to deflect the electron beam, at least intermittent, with a trajectory being incident on the target element, but outside a centre of the target element or an impact region of the target element on which the electron beam is incident in the case of a direction of propagation without deflection, or
wherein the at least one deflection device is configured to deflect the electron beam at least intermittently such that the electron beam is not incident on the target element.

2. (canceled)

3. X-ray source according to claim 1, wherein the at least one deflection device is configured to deflect the electron beam at least intermittently with the trajectory according to a free form so as to be incident on the target element, or to deflect it in individual regions of the target element or sequentially to different regions of the target element, but not to smear it over the different regions of the target element in the region of the target element, for example the electron beam, for example in order to reduce an average local thermal load of the target element in the various regions.

4. X-ray source according to claim 1, wherein the at least one deflection device is configured to deflect the electron beam at least intermittently such that the latter passes radially outside the target element.

5. X-ray source according to claim 4, wherein at least one catching device for the electron beam is provided outside the target element.

6. X-ray source according to claim 5, wherein the at least one catching device extends at least partially along an outer circumference of the target element and/or of the anode body and and/or is thermally coupled to the target element and/or the anode body.

7. X-ray source according to claim 1, wherein the target element has a first region with a first target material and a second region with a second target material which is different from the first target material and the target material includes at least one of the following elements: a) tungsten, b) molybdenum, c) rhodium, d) chromium.

8. X-ray source according to claim 1, having an anode body, wherein the anode body, includes copper or is made of copper and target element is preferably arranged on the anode body.

9. X-ray source according to claim 7, wherein the corresponding first and/or second target material is arranged on the anode body in the first region and/or in the second region in the form of a layer, wherein the first region and/or the second region are of at least one of the following shapes: a) semicircular shape, b) circular shape, c) circular ring shape, d) sector shape, or wherein the first region and the second region are each of semicircular shape or wherein the first region is of circular shape or circular ring shape, wherein the second region is of circular shape or circular ring shape, wherein the second region is arranged concentrically to the first region.

10. (canceled)

11. (canceled)

12. X-ray source according to claim 7, wherein at least one further region with a third target material is provided, wherein the third target material is different from the first and/or second target material.

13. X-ray source according to claim 1, wherein the electron source is configured, sequentially in time, to impinge upon different regions of the target element with the electrons.

14. X-ray source according to claim 1, wherein the at least one deflection device has a deflection stage or a plurality of deflection stages.

15. X-ray source according to claim 9, wherein the at least one deflection device is configured to compensate for stray fields and/or wherein the at least one deflection device has at least two differently configured deflection stages.

16. (canceled)

17. X-ray source according to claim 1, wherein the X-ray source is configured to establish, at least intermittently, a first variable which characterizes a voltage applied between two electrodes of the deflection device.

18. X-ray tube for X-ray fluorescence analysis, with at least one X-ray source according to claim 1, which is provided in a closed tube.

19. Method for operating an X-ray source, having an electron source for providing electrons in the form of an electron beam and a target element which is impinged upon with the electrons of the electron beam,
wherein, through the at least one deflection device, the electron beam is deflected, at least intermittently, with a trajectory to the target element outside a centre of the target element or an impact region of the target element on which the electron beam is incident in the case of a direction of propagation without deflection, or
wherein, through the at least one deflection device, the electron beam is at least intermittently deflected such that the electron beam is not incident on the target element.

20. Method according to claim 19, wherein, through the at least two deflection devices, the electron beam with a trajectory according to an Archimedean spiral from inside to outside or from outside to inside is controlled so as to be incident on the target element, but the centre or the impact region of the target element is not crossed here.

21. Method according to claim 19, wherein, through the at least one deflection device, the electron beam is deflected such that the latter is incident on a catching device which is positioned outside the target element.

22. Method according to claim 21, wherein the at least one catching device is thermally coupled to the target element and/or the anode body and thermal energy generated in the at least one catching device is transferred to the carrier element and/or the anode body.

23. Method according to claim 19, wherein the target element has a first region with a first target material and a second region with a second target material which is different from the first target material, wherein the method includes: impinging upon the first region and/or the second region of the target element with the electrons, in the form of the electron beam, and the impinging preferably includes: impinging upon different regions of the target element with the electrons sequentially in time, and not the centre of the target element.

24. Method according to claim 19, wherein the X-ray source has at least one deflection device for the at least intermittent deflection of the electrons, wherein the method includes at least one of the following elements: a) at least intermittent deflection of the electrons by means of the at least one deflection device to the first region of the target element, such that the electrons are predominantly, incident on the first region, b) at least intermittent deflection of the electrons by means of the at least one deflection device to the second region of the target element, for example such that the electrons are predominantly, incident on the second region, c) at least intermittent deflection of the electrons by means of the at least one deflection device to at least one further region of the target element which is different from the first region and from the second region, such that the electrons are predominantly, incident on the at least one further region, d) at least intermittent deflection of the electrons by means of the at least one deflection device such that the electrons (e), a predominant number of the electrons, are not incident on the target element, pass radially outside the target element, e) deflection of the electrons sequentially to different regions of the target element, in one or two dimensions.

25. Method according to claim 19, further including: optionally, establishing information associated with a, stray field, having a field strength and/or direction, and at least intermittent and/or regional compensating for the stray field by means of the at least one deflection device.

26. Method according to claim 19, further including: establishing a first variable which characterizes a voltage applied between two electrodes of the deflection device, and, operating the deflection device, based on the first variable.

27. Method according to claim 26, wherein the two electrodes are impinged upon, at least intermittently, in a first time domain, with a control voltage to deflect the electrons, and wherein the first variable is established at least intermittently, in a second time domain which lies outside the first time domain.

28. (canceled)

29. (canceled)

30. (canceled)

31. (canceled)

32. Use of the X-ray source according to claim 1 for at least one of the following elements: a) providing different types of X-radiation which differ from one another, in terms of their intensity and/or their spectrum, providing at least two different types of X-radiation sequentially in time and/or alternatingly, b) optimizing the X-ray source and/or a or the X-ray tube for a specifiable application, in the area of X-ray fluorescence analysis, c) carrying out X-ray fluorescence analysis, d) controlling, a thermal load of the target element, in an axis region, e) increasing a service life or durability of the target element, for precise applications, f) reducing, a generation of X-radiation, g) making individual use of at least one region of the target element, h) compensating for stray fields or interference fields, i) smearing the electrons or the electron beam on the target element, j) evaluating a beam position of a or the electron beam, carrying out a diagnosis.

33. X-ray tube according to claim 18, wherein the tube is a glass tube.

34. Use of the X-ray tube according to claim 18 for at least one of the following elements: a) providing different types of X-radiation which differ from one another, in terms of their intensity and/or their spectrum, providing at least two different types of X-radiation sequentially in time and/or alternatingly, b) optimizing the X-ray source and/or a or the X-ray tube for a specifiable application, in the area of X-ray fluorescence analysis, c) carrying out X-ray fluorescence analysis, d) controlling, a thermal load of the target element, in an axis region, e) increasing a service life or durability of the target element, for precise applications, f) reducing, a generation of X-radiation, g) making individual use of at least one region of the target element, h) compensating for stray fields or interference fields, i) smearing the electrons or the electron beam on the target element, j) evaluating a beam position of a or the electron beam, carrying out a diagnosis.

35. Use of the method according to claim 19 for at least one of the following elements: a) providing different types of X-radiation which differ from one another, in terms of their intensity and/or their spectrum, providing at least two different types of X-radiation sequentially in time and/or alternatingly, b) optimizing the X-ray source and/or a or the X-ray tube for a specifiable application, in the area of X-ray fluorescence analysis, c) carrying out X-ray fluorescence analysis, d) controlling, a thermal load of the target element, in an axis region, e) increasing a service life or durability of the target element, for precise applications, f) reducing, a generation of X-radiation, g) making individual use of at least one region of the target element, h) compensating for stray fields or interference fields, i) smearing the electrons or the electron beam on the target element, j) evaluating a beam position of a or the electron beam, carrying out a diagnosis.
